(19) United States
(12) Patent Application Publication
(10) Pub. No.: US 2022/0407095 A1
(43) Pub. Date: Dec. 22, 2022

(54) FUEL CELL STACK PROTECTION METHOD, DEVICE AND FUEL CELL POWER SUPPLY SYSTEM

(71) Applicant: Ceres Intellectual Property Company Limited, Horsham West Sussex (GB)

(72) Inventor: Lei Sun, Weifang, Shandong (CN)

(21) Appl. No.: 17/642,912

(22) PCT Filed: Sep. 16, 2020
(86) PCT No.: PCT/IB2020/058623

§ 371 Date: Mar. 14, 2022

(30) Foreign Application Priority Data
Sep. 16, 2019 (CN) 201910869974.6

(51) Int. Cl. H01M 8/04664; H01M 8/04537; B60L 3/00; B60L 58/30; H02M 1/32

(52) U.S. Cl. CPC H01M 8/04679; H01M 8/04559; B60L 3/0053; B60L 58/30; H02M 1/322; B60L 2210/10

(57) ABSTRACT

The present invention provides a fuel cell stack protection method, a fuel cell stack protection device and a fuel cell power supply system. The method comprises: determining whether a load-dump failure occurs to the fuel cell; controlling the bleeder circuit connected to the output ends of a DC-DC circuit in the fuel cell so as to discharge the DC-DC circuit when a load-dump failure occurs to the fuel cell. When a load-dump failure occurs to the fuel cell, the bleeder circuit connected to the output ends of the DC-DC circuit in the fuel cell is turned on to discharge the DC-DC circuit so that the DC-DC circuit in the fuel cell can continue to output a current, thus preventing the voltage of a fuel cell stack from rising abruptly because of a load-dump failure and preventing any damage caused by a load-dump failure to the fuel cell stack

### TECHNICAL FIELD

The present invention relates to the technical field of new energy vehicles, and in particular relates to a fuel cell stack protection method, device and fuel cell power supply system for fuel cell vehicles where a load-dump failure occurs to the high-voltage circuit.

### BACKGROUND ART

Fuel cell vehicles (FCVs) are vehicles which use the electric power generated by a vehicle-mounted fuel cell device as the power. The fuel used for a vehicle-mounted fuel cell device is high pure hydrogen or a hydrogen-rich reformed gas from a hydrogen-containing fuel. The power for FCVs comes from vehicle-mounted fuel cell devices, while the power for common EVs comes from batteries charged by power grids. Therefore, the key of FCVs is the fuel cell, which directly influences the performance of FCVs.

A load-dump failure is one of the failures which often occur to prior electronic circuits. The type of a load-dump failure varies with the circuit type. For specific definitions and description, see the Automotive Test Standard ISO7637. When a high-voltage outage unexpectedly occurs to the power system of an FCV, the relays in the power distribution unit of the battery management system (BMS) and the all-in-one control unit are open to cut off the connection between the stack of the fuel cell and the DC bus of the vehicle, resulting in a load-dump failure to the stack. In the prior technical solutions, after a load-dump failure occurs to the stack system of a fuel cell, an emergency shutdown is required for the stack. However, the emergency shutdown of the stack will result in a performance degradation of the stack, thus influencing the service life of the stack.

### SUMMARY OF THE INVENTION

In view of this, the embodiments of the present invention provide a fuel cell stack protection method, device and fuel cell power supply system so as to protect the stack of a fuel cell in the case of a load-dump failure to the fuel cell.

To achieve the above-mentioned object, the embodiments of the present invention provide the following technical solutions.

A first aspect provides a fuel cell stack protection method, comprising:
determining whether a load-dump failure occurs to a fuel cell; and
controlling the bleeder circuit connected to the output ends of a DC-DC circuit in the fuel cell so as to discharge the DC-DC circuit when a load-dump failure occurs to the fuel cell.

Controlling the bleeder circuit connected to the output ends of a DC-DC circuit in the fuel cell so as to discharge the DC-DC circuit can comprise:
acquiring the output power of the fuel cell, denoted as a target power, before a load-dump failure occurs; and
controlling the turn-on of the bleeder circuit connected to the output ends of a DC-DC circuit in the fuel cell and regulating the output voltage of the DC-DC circuit according to the output power so that the bleeder power of the bleeder circuit is the target power.

After controlling the bleeder circuit connected to the output ends of a DC-DC circuit in the fuel cell so as to discharge the DC-DC circuit, the fuel cell stack protection method can further comprise:
reducing the amount of fuel injected into the fuel cell according to a first preset gradient;
and
lowering the output voltage of the DC-DC circuit in the fuel cell according to a second preset gradient.

Before lowering the output voltage of a DC-DC circuit in the fuel cell according to a second preset gradient, the method further can comprise:
acquiring a second preset gradient matching the first preset gradient on the basis of a preset gradient mapping list in which the mapping between the first preset gradient and the second preset gradient is stored.

After controlling the bleeder circuit connected to the output ends of a DC-DC circuit in the fuel cell so as to discharge the DC-DC circuit, the fuel cell stack protection method can further comprise:
monitoring the bleeder power of the bleeder circuit in real time, and turning off the bleeder circuit to turn off the stack pre-charging unit in the fuel cell when detecting that the bleeder power of the bleeder circuit drops to a preset safety threshold.

A second aspect provides a fuel cell stack protection device comprising:
a failure detection unit, configured to determine whether a load-dump failure occurs to a fuel cell; and
a bleeder control unit, configured to control the bleeder circuit connected to the output ends of a DC-DC circuit in the fuel cell so as to discharge the DC-DC circuit when a load-dump failure occurs to the fuel cell.

The bleeder control unit can be configured to acquire the output power of the fuel cell, denoted as a target power, before a load-dump failure occurs; control the turn-on of the bleeder circuit connected to the output ends of a DC-DC circuit in the fuel cell and regulate the output voltage of the DC-DC circuit according to the output power so that the bleeder power of the bleeder circuit is the target power.

The fuel cell stack protection device can further comprise:
a fuel regulation unit, configured to reduce the amount of fuel injected into the fuel cell according to a first preset gradient and lower the output voltage of the DC-DC circuit in the fuel cell according to a second preset gradient.

Before lowering the output voltage of a DC-DC circuit in the fuel cell according to a second preset gradient, the fuel regulation unit of the fuel cell stack protection device can be further configured to:
acquire a second preset gradient matching the first preset gradient on the basis of a preset gradient mapping list in which the mapping between the first preset gradient and the second preset gradient is stored.

The bleeder control unit of the fuel cell stack protection device can be further configured to:
monitor the bleeder power of the bleeder circuit in real time, and turn off the bleeder circuit to turn off the stack pre-charging unit in the fuel cell when detecting that the bleeder power of the bleeder circuit drops to a preset safety threshold.

A third aspect provides a fuel cell power supply system comprising a fuel cell controller in which the fuel cell stack protection device is used for the fuel cell controller.

On the basis of the above-mentioned technical solutions provided by the embodiments of the present invention, when a load-dump failure occurs to the fuel cell, the bleeder circuit connected to the output ends of the DC-DC circuit in the fuel cell is turned on to discharge the DC-DC circuit so that the DC-DC circuit in the fuel cell can continue to output a current, thus preventing the voltage of a fuel cell stack from rising abruptly because of a load-dump failure and preventing any damage caused by a load-dump failure to the fuel cell stack.

### BRIEF DESCRIPTION OF THE DRAWINGS

To describe the embodiments of the present invention more clearly, the following briefly describes the drawings required in the description of the embodiments of the invention.

Obviously, the drawings in the following description are only some embodiments of the invention.

FIG. 1 is a flowchart of a fuel cell stack protection method disclosed in an embodiment of the present application.

FIG. 2 is a flowchart of a fuel cell stack protection method disclosed in an embodiment of the present application.

FIG. 3 is a flowchart of a fuel cell stack protection method disclosed in an embodiment of the present application.

FIG. 4 is a flowchart of a fuel cell stack protection method disclosed in an embodiment of the present application.

FIG. 5 is a schematic diagram for the structure of a fuel cell stack protection device disclosed in an embodiment of the present application.

FIG. 6 is a schematic diagram for the structure of a fuel cell power supply system disclosed in an embodiment of the present application.

### DETAILED DESCRIPTION OF THE INVENTION

The following will clearly and completely describe the technical solutions in the embodiments of the present invention in combination with the drawings. Obviously, the described embodiments are only a part, but not all of the embodiments of the present invention. All other embodiments obtained by those skilled in the art on the basis of the embodiments of the present invention without any creative work should fall within the scope of protection of the present invention.

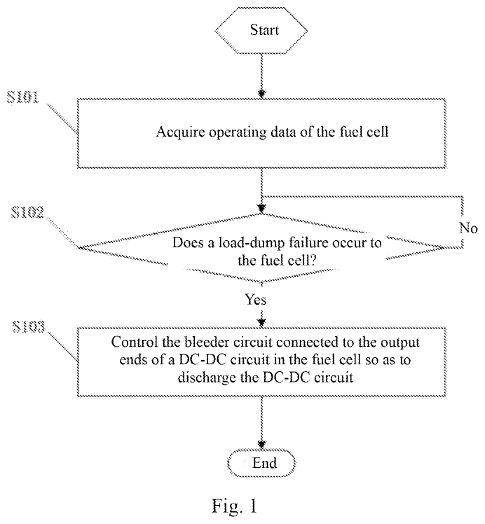

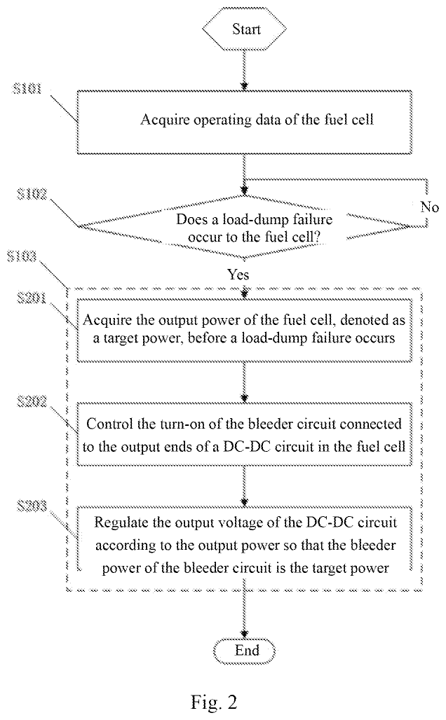

In order to prevent any damage to the stack in the case of a load-dump failure, the present application discloses a fuel cell stack protection method to protect the fuel cell stack. A bleeder circuit is connected to the output ends of the DC-DC circuit in the fuel cell, the input end of the bleeder circuit is connected to the positive output end of the DC-DC circuit, and the output end of the bleeder circuit is connected to the negative output end of the DC-DC circuit. The method can be applied to the fuel cell controller of the fuel cell. As shown in FIG. 1, the method comprises:

Step S101: Acquire the operating data of the fuel cell.

The operating data of the fuel cell is the operating data used to detect whether a load-dump failure occurs to the fuel cell, for example, the current signal output from the output ends of the DC-DC circuit in the fuel cell. When the current output from the output ends of the DC-DC circuit drops abruptly, it indicates that a load-dump failure occurs to the fuel cell. Dropping abruptly may mean that the difference between the current output from the output ends of the DC-DC circuit at a current point of time and the current output from the output ends of the DC-DC circuit at a previous point of time is greater than a preset current difference.

Step S102: Determine whether a load-dump failure occurs to the fuel cell on the basis of the operating data and perform step S103 if a load-dump failure occurs to the fuel cell.

When the operating data is the current output from the output ends of the DC-DC circuit, determine whether the current output from the output ends of the DC-DC circuit drops abruptly. If the current drops abruptly (indicating that a load-dump failure occurs to the fuel cell), perform step S103, and otherwise continue to monitor the current output from the output ends of the DC-DC circuit.

Step S103: Control the bleeder circuit connected to the output ends of the DC-DC circuit in the fuel cell to discharge the DC-DC circuit.

In the technical solution disclosed in the embodiment of the present application, when a load-dump failure to the fuel cell is monitored, the bleeder circuit connected to the output ends of the DC-DC circuit is turned on, and the bleeder circuit discharges the DC-DC circuit to consume the electric energy output from the DC-DC circuit, thus preventing an abrupt voltage rise of the fuel cell stack.

From the above-mentioned technical solution, it can be seen that the working condition of the fuel cell is analysed according to the operating data of the fuel cell in the present application. When a load-dump failure occurs, the bleeder circuit connected to the output ends of the DC-DC circuit in the fuel cell is turned on to discharge the DC-DC circuit so that the DC-DC circuit in the fuel cell can continue to output a current, thus preventing the voltage of a fuel cell stack from rising abruptly because of a load-dump failure and preventing any damage caused by a load-dump failure to the fuel cell stack.

The bleeder power of the bleeder circuit depends on the output voltage U of the DC-DC circuit and the equivalent resistance R of the bleeder circuit, that is to say, the bleeder power of the bleeder circuit is U²/R. Therefore, the bleeder voltage of the bleeder circuit can be regulated by regulating the output voltage U of the DC-DC circuit or the equivalent resistance R of the bleeder circuit so that the bleeder voltage is consistent with the output voltage before a load-dump failure and the change of the output voltage of the stack is the minimum, thus reducing the damage caused by the load-dump failure to the stack to the greatest extent and protecting the stack effectively. In view of this, in the technical solution disclosed in the above-mentioned embodiment of the present application, controlling the bleeder circuit connected to the output ends of the DC-DC circuit in the fuel cell to discharge the DC-DC circuit comprises:

Step S201: Acquire the output power of the fuel cell, denoted as a target power, before a load-dump failure occurs.

In this step, the output power of the fuel cell before a load-dump failure is obtained by calculating the operating data of the fuel cell before a load-dump failure, and the output power is denoted as a target power of the bleeder circuit.

Step S202: Control turn-on of the bleeder circuit connected to the output ends of a DC-DC circuit in the fuel cell.

After the bleeder circuit is turned on, the output current of the DC-DC circuit flows into the bleeder circuit and is consumed by the resistor on the bleeder circuit.

Step S203: Regulate the output voltage of the DC-DC circuit according to the output power so that the bleeder power of the bleeder circuit is the target power.

In this step, in order to keep the output power of the fuel cell consistent with the output power before a load-dump failure, the bleeder power of the bleeder circuit can be increased or reduced by regulating the output voltage of the DC-DC circuit so that the bleeder power of the bleeder circuit is the target power. Of course, the bleeder power of the bleeder circuit can also be regulated by regulating the equivalent resistance of the bleeder circuit.

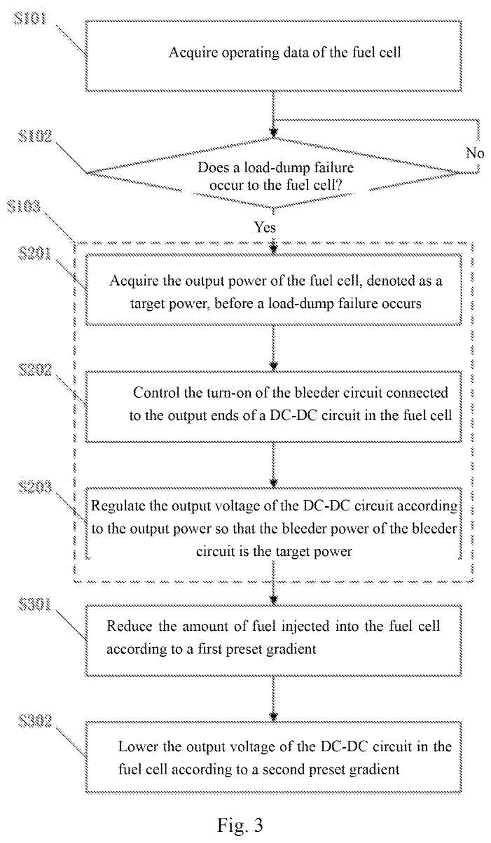

In the technical solution disclosed in the embodiment of the present application, after a load-dump failure to the fuel cell is detected, for the purpose of lowering the energy waste, the amount of fuel supplied to the fuel cell needs to be reduced gradually until the fuel cell stops working. For details, see FIG. 3. In the above-mentioned technical solution, after controlling the bleeder circuit connected to the output ends of a DC-DC circuit in the fuel cell so as to discharge the DC-DC circuit, the method further comprises:

Step S301: Reduce the amount of fuel injected into the fuel cell according to a first preset gradient.

Step S302: Lower the output voltage of the DC-DC circuit in the fuel cell according to a second preset gradient.

The first preset gradient and the second preset gradient can be preset by the user according to the design requirements. Of course, if the amount of fuel injected into the fuel cell is different, the voltage allowed to be output from the output ends of the DC-DC circuit in the fuel cell will also be different. In view of this, the second preset gradient can be determined according to the first preset gradient. That is to say, before lowering the output voltage of the DC-DC circuit in the fuel cell according to a second preset gradient, the method further comprises: acquiring a second preset gradient matching the first preset gradient on the basis of a preset gradient mapping list in which the mapping between the first preset gradient and the second preset gradient is stored. The preset mapping is created in advance. The second preset gradient can be obtained by looking up the preset gradient mapping list on the basis of the known first preset gradient.

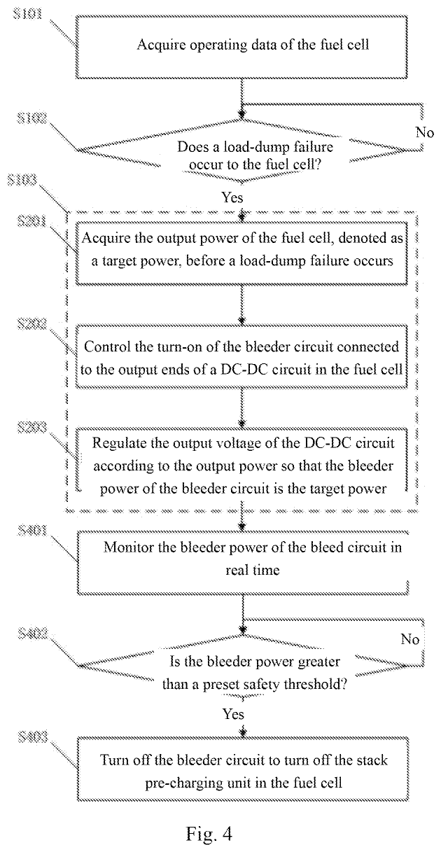

In the technical solution disclosed in the above-mentioned embodiment of the present application, when the output power of the fuel cell drops below a safety threshold, the fuel cell can be shut down. In this case, the shutdown of the fuel cell will not influence the service life of the fuel cell. Since the bleeder power of the bleeder circuit can represent the output power of the fuel cell, whether the fuel cell can be shut down or not can be determined by detecting the bleeder power. For details, see FIG. 4. After controlling the bleeder circuit connected to the output ends of a DC-DC circuit in the fuel cell so as to discharge the DC-DC circuit, the method further comprises:

Step S401: Monitor the bleeder power of the bleeder circuit in real time.

The bleeder power can be obtained through calculations based on the output voltage of the DC-DC circuit and the equivalent resistance of the bleeder circuit.

Step S402: Determine whether the bleeder power is greater than a preset safety threshold and if the detected bleeder power of the bleeder circuit drops to the preset safety threshold, perform step S403.

Step S403: Turn off the bleeder circuit to turn off the stack pre-charging unit in the fuel cell.

In the above-mentioned technical solution, the preset safety threshold can be set by the user according to the requirements of the user. Further, the preset safety threshold can be regulated according to the degree of aging of the fuel cell. This is because when the fuel cell is shut down, the higher the degree of aging of the fuel cell is, the greater the impact of a current on the fuel cell is. Therefore, if the same preset safety threshold is adopted for a brand-new fuel cell and a fuel cell used for a period of time, the damage caused by a shutdown to the fuel cell used for a period of time is heavier than the damage to the brand-new fuel cell. In view of this, in the technical solution disclosed in the embodiment of the present application, the preset safety threshold can further be preset according to the degree of aging of the fuel cell, wherein the degree of aging of the fuel cell can be obtained through calculations based on the working hours of the fuel cell and the corresponding output power of the fuel cell for different working hours, and wherein the mappings between degrees of aging and preset safety thresholds can be obtained by looking up a table. After the degree of aging is obtained, a preset safety threshold corresponding to the degree of aging can be obtained by looking up the table.

The present application further discloses a fuel cell stack protection device. For particular work of the units of the fuel cell stack protection device, please see the content of the above-mentioned method embodiments. The following describes the fuel cell stack protection device provided by the embodiment of the present invention. A reference can be made to the description of the fuel cell stack protection method in the description of the fuel cell stack protection device below.

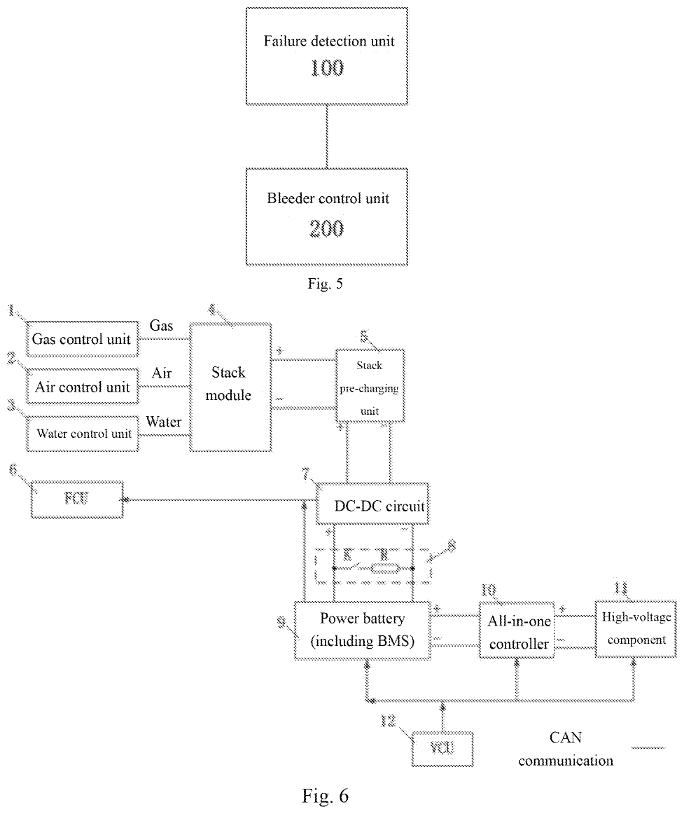

As shown in FIG. 5, the fuel cell stack protection device comprises a failure detection unit 100, configured to determine whether a load-dump failure occurs to a fuel cell; and a bleeder control unit 200, configured to control the bleeder circuit connected to the output end of a DC-DC circuit in the fuel cell so as to discharge the DC-DC circuit when a load-dump failure occurs to the fuel cell.

Corresponding to the above-mentioned method, in the fuel cell stack protection device, the bleeder control unit is particularly configured to acquire the output power of the fuel cell, denoted as a target power, before a load-dump failure occurs; control the turn-on of the bleeder circuit connected to the output ends of a DC-DC circuit in the fuel cell and regulate the output voltage of the DC-DC circuit according to the output power so that the bleeder power of the bleeder circuit is the target power.

Corresponding to the above-mentioned method, the fuel cell stack protection device further comprises a fuel regulation unit, configured to reduce the amount of fuel injected into the fuel cell according to a first preset gradient and lower the output voltage of the DC-DC circuit in the fuel cell according to a second preset gradient.

Corresponding to the above-mentioned method, before lowering the output voltage of a DC-DC circuit in the fuel cell according to a second preset gradient, the fuel regulation unit of the fuel cell stack protection device is further configured to acquire a second preset gradient matching the first preset gradient on the basis of a preset gradient mapping list in which the mapping between the first preset gradient and the second preset gradient is stored.

Corresponding to the above-mentioned method, the bleeder control unit of the fuel cell stack protection device is further configured to monitor the bleeder power of the bleeder circuit in real time, and turn off the bleeder circuit to turn off the stack pre-charging unit in the fuel cell when detecting that the bleeder power of the bleeder circuit drops to a preset safety threshold.

Corresponding to the above-mentioned method, the fuel cell stack protection device may further comprise a safety threshold regulation unit, configured to automatically regulate the preset safety threshold according to the degree of aging of the fuel cell, wherein the degree of aging of the fuel cell can be obtained through calculations based on the working hours of the fuel cell and the corresponding output power of the fuel cell for different working hours, and wherein the mappings between degrees of aging and preset safety thresholds can be obtained by looking up a table. After the degree of aging is obtained, a preset safety threshold corresponding to the degree of aging can be obtained by looking up the table.

Corresponding to the fuel cell stack protection device, the present application further discloses a fuel cell power supply system, the fuel cell power supply system is configured with a fuel cell controller, and the fuel cell stack protection device described in any embodiment of the present application is used for the fuel cell controller.

For details, see FIG. 6. The fuel cell power supply system may comprise a gas control unit 1, an air control unit 2, a water control unit 3, a stack module 4 (above-mentioned stack), a stack pre-charging unit 5, a fuel cell control unit (FCU) 6, a DC-DC circuit 7, a bleeder circuit 8, a power battery 9 (including a BMS), an all-in-one controller 10, a high-voltage component 11 and a vehicle control unit (VCU) 12.

Particularly, the output ends of the gas control unit 1, the air control unit 2 and the water control unit 3 are connected to the input ends of the stack module 4, the gas control unit 1 is configured to control the amount of gas injected into the stack module 4, the gas control unit 2 is configured to control the amount of air injected into the stack module 4, and the water control unit 3 is configured to control the amount of water injected into the stack module 4.

The stack pre-charging unit 5 is disposed between the output ends of the stack module 4 and the input ends of the DC-DC circuit 7, the bleeder circuit 8 is connected in parallel to the two output ends of the DC-DC circuit 7, the fuel cell control unit (FCU) 6 is connected to the DC-DC circuit and the power battery 9 and is configured to acquire operating data of the DC-DC circuit 7 and the power battery 9 and send a control command to the DC-DC circuit 7 and the power battery 9.

The all-in-one controller 10 is disposed between the output ends of the power battery 9 and the input ends of the high-voltage component 11, the vehicle control unit (VCU) 12 is connected to the power battery 9, the all-in-one controller 10 and the high-voltage component 11 and is configured to acquire operating data of the power battery 9, the all-in-one controller 10 and the high-voltage component 11 and send a control command to the power battery 9, the all-in-one controller 10 and the high-voltage component 11.

The structure of the bleeder circuit 8 may be set according to the user requirements. For example, as shown in FIG. 4, the bleeder circuit 8 in the technical solution disclosed in the embodiment of the present application consists of a power electronic switch K and a power resistor R connected in series. One end of the series branch consisting of the power electronic switch K and the power resistor R is connected to the positive output end of the DC-DC circuit and the other end is connected to the negative output end. Thus, it can be seen that the bleeder circuit is connected to the DC bus of the power battery. The power electronic switch of the bleeder circuit may be a non-contact power device such as a solid-state relay, an insulated gate bipolar transistor (IGBT) and a SiC tube, and the power resistor R may be an adjustable power resistor.

When a high-voltage outage unexpectedly occurs to the power system of an EV, the relays in the power distribution unit of the battery management system (BMS) and the all-in-one control unit are open to cut off the connection between the stack and the DC bus of the vehicle, resulting in a load-dump failure to the stack. In this case, the fuel cell stack protection device in the FCU 6 will detect an abrupt drop of the output current of the DC-DC circuit 7, determine that a load-dump failure occurs to the fuel cell and then perform the follow-up actions.

In a word, in the technical solutions disclosed in the embodiments of the present application, after a load-dump failure occurs to the high-voltage circuit of the fuel cell, the bleeder circuit is immediately switched to the output ends of the DC-DC circuit to prevent a load-dump failure to the stack. In addition, the physical parameters of gas, air and water injected into the stack are controlled. Thus, the stack is protected effectively and safety of the system is improved.

By letting FCU control the bleeder circuit, the bleeder resistor can quickly be switched to the stack load to prevent a dramatic change of the stack voltage. In addition, the stack enters he power reduction mode and safe shutdown mode under control, effectively preventing a performance degradation of the stack and prolonging the service life of the stack.

For the convenience of description, when the system is described, the system is functionally divided into different modules and these modules are described respectively. Of course, the functions of different modules can be realised in one or more pieces of software and/or hardware when the present invention is implemented.

The embodiments in the description are described in a progressive way. For the same or similar parts between the embodiments, refer to these embodiments. Each embodiment focuses on the differences from the others. In particular, the description of the system or the embodiments of the system is simple because they are similar to the embodiments of the method. For the related parts, see the description of the embodiments of the method. The above-mentioned system and system embodiments are given only for an exemplary purpose. The unit or module described as a separate part may or may not be physically separated, and the part shown as a unit may or may not be a physical unit, that is to say, it may be located at one place or may be distributed to a plurality of network units. Part or all of the modules may be selected to realise the solution in the embodiments according to the actual requirement. Those skilled in the art can understand and implement the solution without any creative work. Those skilled in the art may further realise that the exemplary units and algorithm steps depicted in the embodiments disclosed in this document may be realised by use of electronic hardware, computer software or the combination of both. To clearly describe the interchangeability of hardware and software, the compositions and steps in the examples have generally been depicted by function. Whether these functions are implemented by hardware or software depends on the specific application and design constraints of the technical solutions. Those skilled in the art may use different methods for each specific application to implement the depicted functions, but it should not be considered that such an implementation goes beyond the scope of the present invention.

The method or algorithm steps depicted in the embodiments disclosed in this document can be implemented by directly using hardware, software modules executed by processors or the combination of both. Software modules can be disposed in a RAM, memory, ROM, electrically programmable ROM, electrically erasable programmable ROM, register, hard disk, removable disk, DC-ROM or storage medium in any other known form in the art.

It should be noted that the terms such as first and second in the present application are only used to distinguish one entity or operation from another entity or operation, but do not require or imply any actual relationship or sequence between the entities or operations. In addition, the terms “comprise” and “include” and their variants are intended to cover non-exclusive inclusions so that the process, method, article or device comprising a series of elements not only comprises these elements, but also comprises other elements not listed clearly, or comprises the elements intrinsic to the process, method, article or device. Without any more restrictions, the element defined by “comprising one . . . ” does not exclude the case that other identical elements exist in the process, method, article or device which comprises the element.

The description of the disclosed embodiments enables those skilled in the art to realise or use the present invention. Various modifications to these embodiments are obvious to those skilled in the art. The general principles defined in this document can be implemented in other embodiments without departing from the spirit or scope of the present invention. Accordingly, the present invention is not limited to the embodiments in this document, but complies with the widest scope consistent with the principle and the novelty feature disclosed in this document.

1. A fuel cell stack protection method, comprising:
determining whether a load-dump failure occurs to a fuel cell; and
controlling a bleeder circuit connected to the output ends of a DC-DC circuit in the fuel cell so as to discharge the DC-DC circuit when a load-dump failure occurs to the fuel cell.

2. The fuel cell stack protection method as claimed in claim 1, characterised in that controlling the bleeder circuit connected to the output ends of a DC-DC circuit in the fuel cell so as to discharge the DC-DC circuit comprises:
acquiring the output power of the fuel cell, denoted as a target power, before a load-dump failure occurs; and
controlling the turn-on of the bleeder circuit connected to the output ends of the DC-DC circuit in the fuel cell and regulating the output voltage of the DC-DC circuit according to the output power so that the bleeder power of the bleeder circuit is the target power.

3. The fuel cell stack protection method as claimed in claim 1, characterised in that after controlling the bleeder circuit connected to the output ends of a DC-DC circuit in the fuel cell so as to discharge the DC-DC circuit, the method further comprises:
reducing the amount of fuel injected into the fuel cell according to a first preset gradient; and
lowering the output voltage of the DC-DC circuit in the fuel cell according to a second preset gradient.

4. The fuel cell stack protection method as claimed in claim 3, characterised in that before lowering the output voltage of a DC-DC circuit in the fuel cell according to a second preset gradient, the method further comprises:
acquiring a second preset gradient matching the first preset gradient on the basis of a preset gradient mapping list in which the mapping between the first preset gradient and the second preset gradient is stored.

5. The fuel cell stack protection method as claimed in claim 1, characterised in that after controlling the bleeder circuit connected to the output ends of a DC-DC circuit in the fuel cell so as to discharge the DC-DC circuit, the method further comprises:
monitoring the bleeder power of the bleeder circuit in real time, and turning off the bleeder circuit to turn off the stack pre-charging unit in the fuel cell when detecting that the bleeder power of the bleeder circuit drops to a preset safety threshold.

6. A fuel cell stack protection device, comprising:
a failure detection unit, configured to determine whether a load-dump failure occurs to a fuel cell; and
a bleeder control unit, configured to control the bleeder circuit connected to the output ends of a DC-DC circuit in the fuel cell so as to discharge the DC-DC circuit when a load-dump failure occurs to the fuel cell.

7. The fuel cell stack protection device as claimed in claim 6, characterised in that the bleeder control unit is configured to:
acquire the output power of the fuel cell, denoted as a target power, before a load-dump failure occurs; and
control the turn-on of the bleeder circuit connected to the output ends of a DC-DC circuit in the fuel cell and regulate the output voltage of the DC-DC circuit according to the output power so that the bleeder power of the bleeder circuit is the target power.

8. The fuel cell stack protection device as claimed in claim 6, characterised in that the device further comprises:
a fuel regulation unit, configured to reduce the amount of fuel injected into the fuel cell according to a first preset gradient and lower the output voltage of the DC-DC circuit in the fuel cell according to a second preset gradient.

9. The fuel cell stack protection device as claimed in claim 6, characterised in that the bleeder control unit is further configured to:
monitor the bleeder power of the bleeder circuit in real time, and turn off the bleeder circuit to turn off the stack pre-charging unit in the fuel cell when detecting that the bleeder power of the bleeder circuit drops to a preset safety threshold.

10. A fuel cell power supply system, comprising a fuel cell controller comprising a fuel cell stack protection device as claimed in claim 6.
